(19) United States
(12) Patent Application Publication
(10) Pub. No.: US 2020/0062175 A1
(43) Pub. Date: Feb. 27, 2020

(54) VISIBLE LIGHT COMMUNICATION FOR EMERGENCY REQUEST

(71) Applicant: Ford Global Technologies, LLC, Dearborn, MI (US)

(72) Inventors: Yun Ho Lee, Pleasanton, CA (US); Jayanthi Rao, West Bloomfield, MI (US); Mike Ryan, Monte Sereno, CA (US)

(73) Assignee: Ford Global Technologies, LLC, Dearborn, MI (US)

(21) Appl. No.: 16/109,353

(22) Filed: Aug. 22, 2018

(51) Int. Cl. B60Q 1/52; B60Q 1/26

(52) U.S. Cl. CPC B60Q 1/52; B60Q 1/2611

(57) ABSTRACT

One or more processors associated with a vehicle can be configured to determine whether a condition exists that requires a request for assistance, such as a vehicle malfunction, a passenger emergency, and so forth. In response to a determination that the condition exists, the processor(s) determine availability of remote objects or devices with which the vehicle can communicate wirelessly. In response to a determination that no remote object or device is available, the processor(s) cause a visible light communication (VLC) transmitter to transmit the request for assistance.

### TECHNICAL FIELD

The present disclosure generally relates to visible light communication (VLC) and, more particularly, to VLC for emergency requests in an out-of-network area.

### BACKGROUND

In an area with no network connection, such as desert, mountain, or any connectivity shaded area, it may be difficult to find connectivity to a mobile/cellular network or a Wi-Fi network. When a vehicle gets lost in the middle of such an out-of-network area, it would be up to the lost vehicle or its driver to establish communications with a wireless network within a reachable distance. In such cases, most likely the lost vehicle needs to be found by a rescue unit or another vehicle which happens, by chance, to be traveling nearby.

If the vehicle has cellular-based vehicle-to-everything (C-V2X) or dedicated short-range communication vehicle-to-everything (DSRC V2X), the lost vehicle might be able to reach out to another vehicle passing nearby, but the reachable distance may be about 300 to about 600 meters or less, depending on the communication protocol. Moreover, the wireless channel between the lost vehicle and another vehicle that is passing by may use line-of-sight because C-V2X and DSRC can use 5.9 GHz frequency, which has higher signal attenuation for diffraction, reflection, scattering, and low signal penetration for obstructions.

If the lost vehicle has a satellite communication system, it might be able to connect to a satellite network, but the lost vehicle may have to wait for an available satellite or a satellite that has an antenna with a certain amount of power. This, however, may be difficult to implement for vehicles. In addition, accessibility to satellite communication may be costly.

In case of an emergency in an out-of-network area, a rescue unit may be deployed to find the lost vehicle. The rescue unit may use visual search in instances where there is no available connectivity between the rescue unit and the lost vehicle. Accordingly, rescue may not be possible during dark/nighttime when visual search strategies are being implemented.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram of an example use case in which embodiments in accordance with the present disclosure may be implemented.

FIG. 2 is a diagram of example use cases in accordance with embodiments of the present disclosure.

FIG. 3 is a diagram of an example method of VLC communication in accordance with an embodiment of the present disclosure.

FIG. 4A and FIG. 4B each provide a diagram of example systems in accordance with embodiments of the present disclosure.

FIG. 5 is a flowchart depicting an example process in accordance with an embodiment of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

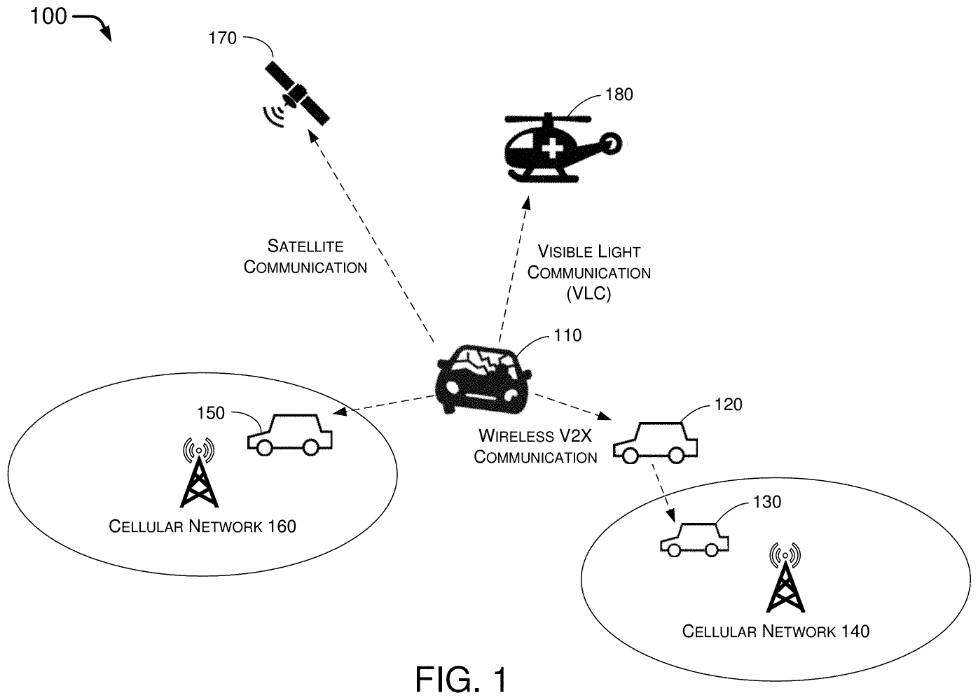

FIG. 1 illustrates an example use case 100 in which embodiments in accordance with the present disclosure may be implemented. Use case 100 includes a vehicle 110 that can wirelessly communicate with one or more other remote objects or devices such as, for example, one or more other vehicles (e.g., another vehicle 120, etc.), using one or more wireless networks such as a Wi-Fi network, cellular network 140 and/or cellular network 160, and/or one or more satellites such as satellite 170. Vehicle 110 may be configured to communicate wirelessly with other vehicles, mobile communication devices, satellites and wireless networks according to suitable standards, specifications and protocols such as, for example, Institute of Electrical and Electronics Engineers (IEEE) 802.11 specifications (e.g., Wi-Fi), Bluetooth, Near Field Communication (NFC), vehicle-to-vehicle (V2V), vehicle-to-everything (V2X), and cellular network protocols (e.g., Long-Term Evolution (LTE), 5^{th} Generation (5G) and New Radio (NR)). For instance, when within a pertinent range of wireless communication, vehicle 110 may communicate via V2V with vehicle 120, which may communicate via V2V with yet another vehicle 130 that is within a cellular communication range of cellular network 140 Similarly, when within a pertinent range of wireless communication, vehicle 110 may communicate via V2V with a vehicle 150 that is within a cellular communication range of cellular network 160. Moreover, when within a pertinent range of wireless communication, vehicle 110 may directly communicate with cellular network 140 or 160. Additionally, when within a line of sight, vehicle 110 may communicate with satellite 170.

When vehicle 110 (or its passenger(s)) is in need of assistance during an instance where vehicle 110 is in an out-of-network area (e.g., having no communication connection with any remote object such as vehicle 120, vehicle 130, cellular network 140, vehicle 150, cellular network 160, satellite 170, etc.) or when communications systems are malfunctioning, it may be difficult for vehicle 110 (as well as its passenger(s)) to transmit a request for assistance. For instance, when traveling in an out-of-network area and encountering a situation or emergency such that vehicle 110 cannot travel further to an area in which there is an available network connection (e.g., due to reasons such as blocked roads, being out of gas, being included in a crash or accident, having a flat tire, etc.), vehicle 110 may rely on visible light communication (VLC) to transmit necessary information, such as information related to vehicle 110 and/or its passenger(s)), to a rescue unit 180. Rescue unit 180 may be a helicopter, plane, balloon, drone, or any object at ground level or flying high that is able to see a wide area. In some cases, rescue unit 180 may include a fixed VLC receiver.

When a VLC system in accordance with the present disclosure is implemented, vehicle 110 may utilize the VLC system to transmit a signal by emitting a visible light with information (e.g., information may be encoded in the visible light transmission, etc.) related to the vehicle and/or its passenger(s) encoded in the signal so that rescue unit 180 may visualize, detect or otherwise record such a signal. Moreover, rescue unit 180 (which may be a ground-based or air-based rescue unit) may demodulate a pre-defined VLC modulation to decode information encoded in the signal. Once rescue unit 180 detects the VLC communication from vehicle 110, rescue unit 180 may identify and locate the lost vehicle 110. Thus, the VLC system in accordance with the present disclosure may help save lives and/or provide assistance in emergency cases.

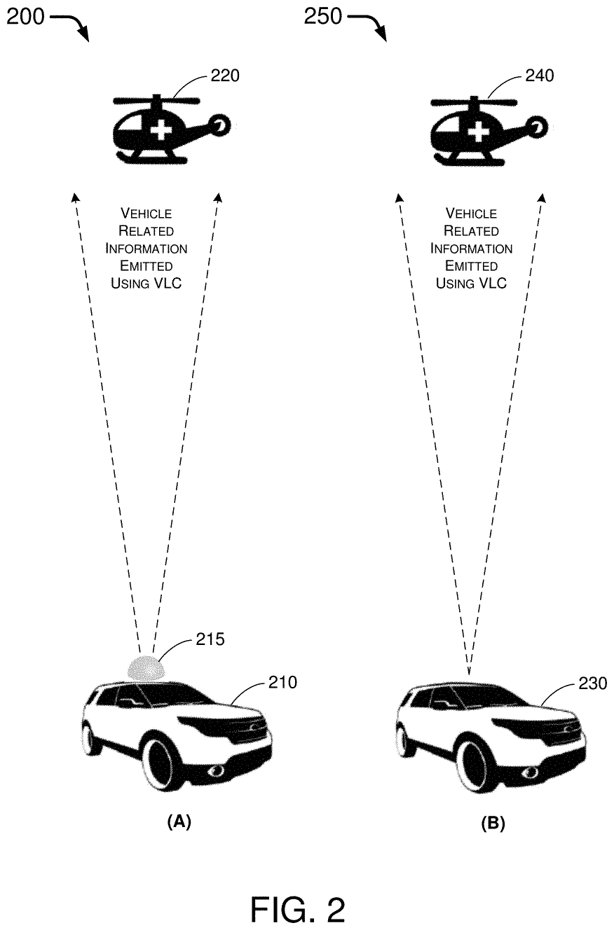

FIG. 2 illustrates example use cases 200 and 250 in accordance with embodiments of the present disclosure. Referring to part (A) of FIG. 2, in use case 200, a vehicle 210 may be carrying or otherwise equipped with a VLC transmitter accessory 215 which may be portably moved and placed, for example by a user, at a suitable location and/or in a suitable orientation on or near vehicle 210. VLC transmitter accessory 215 may be communicatively connected to vehicle 210 by wire or wirelessly. Accordingly, a passenger (e.g., driver) of vehicle 210 may place the VLC transmitter accessory 215 on vehicle 210 (e.g., on top of the roof or a highest point thereof) in an orientation such that a beam of visible light emitted by VLC transmitter accessory 215 is toward the open sky, or skyward, thereby making it easy for a rescue unit 220 (e.g., a rescue helicopter or a rescue drone) flying over an area in which vehicle 210 is located to detect the visible light. That is, a human operator or a camera associated with rescue unit 220 may detect the visible light emitted by VLC transmitter accessory 215 and then decode a signal in the emitted light to obtain information related to vehicle 210 and/or passenger(s) thereof.

Referring to part (B) of FIG. 2, in scenario 250, a vehicle 230 may be capable of emitting visible lights for VLC by using one or more of light sources thereof. For instance, a beam of light for VLC may be transmitted from vehicle 230 itself through, for example and without limitation, any of the following: side mirror indicator lights, the backside of rearview mirror, tail lights, part of shark-fin antenna, one or more edges of roof rail, head lights, fog lights, tail lights, and a roof-top light. The direction of VLC light may be upward towards the sky, in a front, rear, or side orientation at ground level, or in another direction. The vehicle 230 may utilize one or more sensors to detect and determine a general direction which is skyward in one example. For instance, a sensor, such as a camera or an ambient light sensor, may be utilized to detect the direction of the open sky when a VLC emergency request is enabled, whether automatically by vehicle 230 or by a passenger thereof, and the VLC system of vehicle 230 may either adjust the direction of a VLC transmitter and/or choose at least one VLC transmitter from multiple available VLC transmitters equipped on vehicle 230, such that the adjusted or chosen VLC transmitter may be used to transmit encoded information by emitting a visible light from vehicle 230. Accordingly, a rescue unit 240 (e.g., a rescue helicopter or a rescue drone) that may be driving near or flying over an area in which vehicle 230 is located may detect the visible light. For example, a human operator or a camera associated with rescue unit 240 may detect the visible light emitted by vehicle 230 and then decode a signal in the emitted light to obtain information related to vehicle 230 and/or passenger(s) thereof.

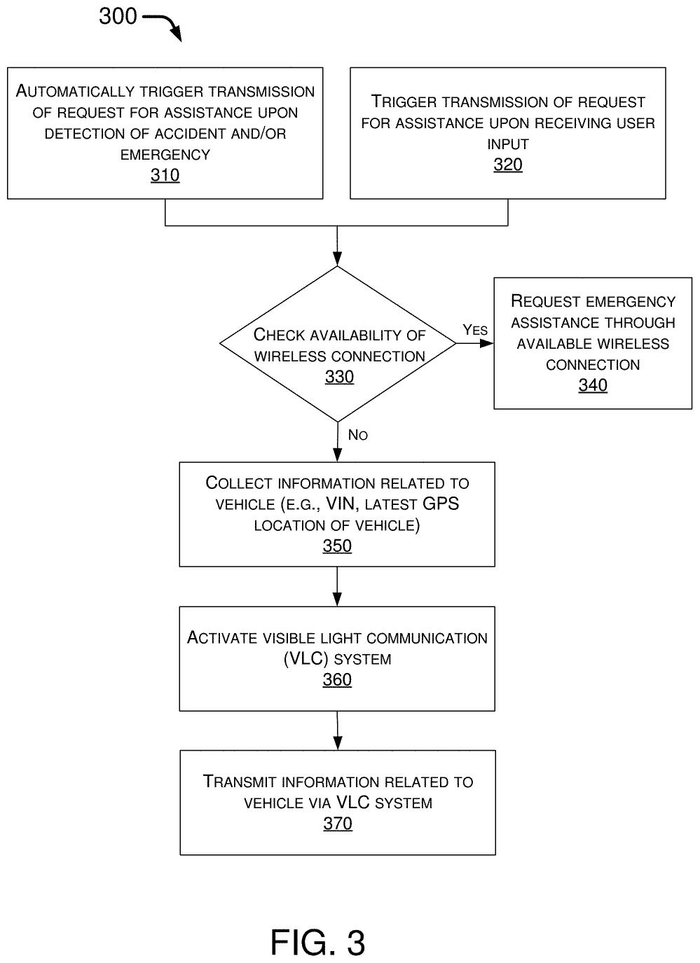

FIG. 3 illustrates an example process flow 300 of VLC communication in accordance with an embodiment of the present disclosure. Process flow 300 may include one or more operations, actions, or functions shown as blocks such as 310, 320, 330, 340, 350, 360 and 370 of FIG. 3. Although illustrated as discrete blocks, various blocks of process flow 300 may be divided into additional blocks, combined into fewer blocks, or eliminated, depending on the desired implementation. Process flow 300 may be implemented in or by one or more of vehicle 110, vehicle 210 and/or vehicle 230 as described above. Process flow 300 may begin at any of the blocks.

At block 310, process flow 300 may include a vehicle (e.g., vehicle 110, vehicle 210 and/or vehicle 230, etc.) automatically triggering transmission of a request for assistance upon detection of an accident, emergency, or other event. For instance, the vehicle may automatically trigger the transmission of a visible light for VLC communication upon detecting a condition such as, for example and without limitation, the vehicle being out of gas, the vehicle being included in a crash or accident, the vehicle having a flat tire, a passenger having a medical emergency, another vehicle having mechanical and/or communication trouble, and so forth. That is, an emergency request may be enabled by any sensor of the vehicle based on one or more settings, which may be pre-configured, and may be implemented automatically if a passenger is unable to do so. Thus, when the vehicle detects an accident or other event has occurred (e.g., detection of an impact, launch of airbag(s), detection by camera or radar, and/or detection of vehicle malfunction, etc.) by one or more sensors, process flow 300 may proceed from 310 to 330.

At block 320, process flow 300 may include the vehicle triggering the transmission of the request for assistance upon receiving a user input. For instance, a passenger of the vehicle may manually trigger the transmission of the request for assistance with the user input, which may be, for example and without limitation, a voice command, a touch command provided on a touch-sensing panel, a push of a button, and so forth. Upon receiving the user input, the vehicle may transmit a visible light for VLC communication. Thus, in case of accident, emergency, or other event, the passenger may manually trigger, activate, or otherwise initiate the VLC system to transmit an emergency request. Moreover, when the driver/passenger needs assistance regardless of accident or emergency (e.g., having lost their way in a desert or in mountains), the driver/passenger may manually trigger, activate or otherwise initiate the VLC system to transmit an emergency request. Process flow 300 may proceed from block 320 to block 330.

At block 330, process flow 300 may include the vehicle checking availability of wireless connection with any remote object such as, for example, a vehicle (e.g., vehicle 120 and/or vehicle 150, etc.), a mobile communication device (e.g., a smartphone carried by a pedestrian or passenger, etc.), a satellite (e.g., satellite 170, etc.) or a wireless network (e.g., cellular network 140 and/or cellular network 160, etc.) with which the vehicle can communicate wirelessly. In an event that wireless connection with at least one remote object is available, process flow 300 may proceed from 330 to 340. Otherwise, in an event that there is no wireless connection with any remote object is available, process flow 300 may proceed from 330 to 350.

At block 340, process flow 300 may include the vehicle requesting for emergency assistance through the available wireless connection (e.g., via Wi-Fi, Bluetooth, NFC, V2V, V2X, and/or and cellular network protocols) without (in some instances) utilizing VLC communication.

At block 350, process flow 300 may include the vehicle collecting or otherwise obtaining information related to the vehicle and/or passenger(s) of the vehicle. For instance, the vehicle may collect such information from one or more sensors and/or a memory of the vehicle. The information related to the vehicle may include, for example and without limitation, a Global Positioning System (GPS) location of the vehicle, a vehicle identification number (VIN) of the vehicle, a timestamp, a name of a passenger of the vehicle, a condition of the vehicle, a condition of the passenger, or a combination thereof. The condition of the vehicle may include, for example and without limitation, an impact experienced by the vehicle, a condition of brakes of the vehicle, a temperature of the vehicle, a level of a battery of the vehicle, a level of a gas tank of the vehicle, a speed history of the vehicle, a path history of the vehicle, and/or a combination thereof. Process flow 300 may proceed from block 350 to block 360.

At block 360, process flow 300 may include the vehicle activating a VLC system associated with the vehicle. Process flow 300 may proceed from block 360 to block 370.

At block 370, process flow 300 may include the vehicle transmitting information related to the vehicle and/or its passenger(s) via the VLC system. For instance, the vehicle may cause one or more VLC transmitters of the VLC system to emit one or more visible lights with information related to the vehicle and/or passenger(s) encoded in the visible light.

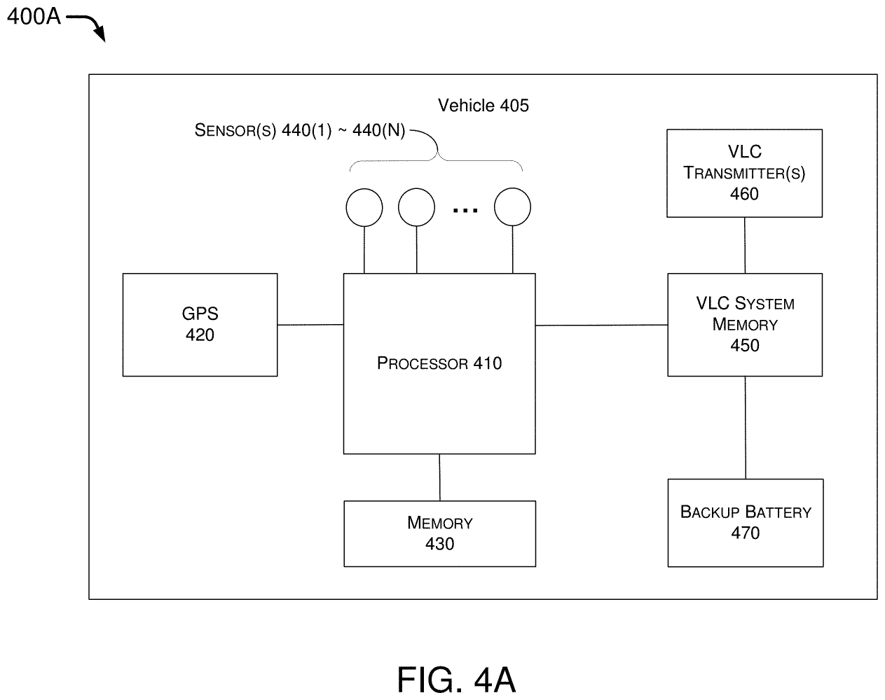

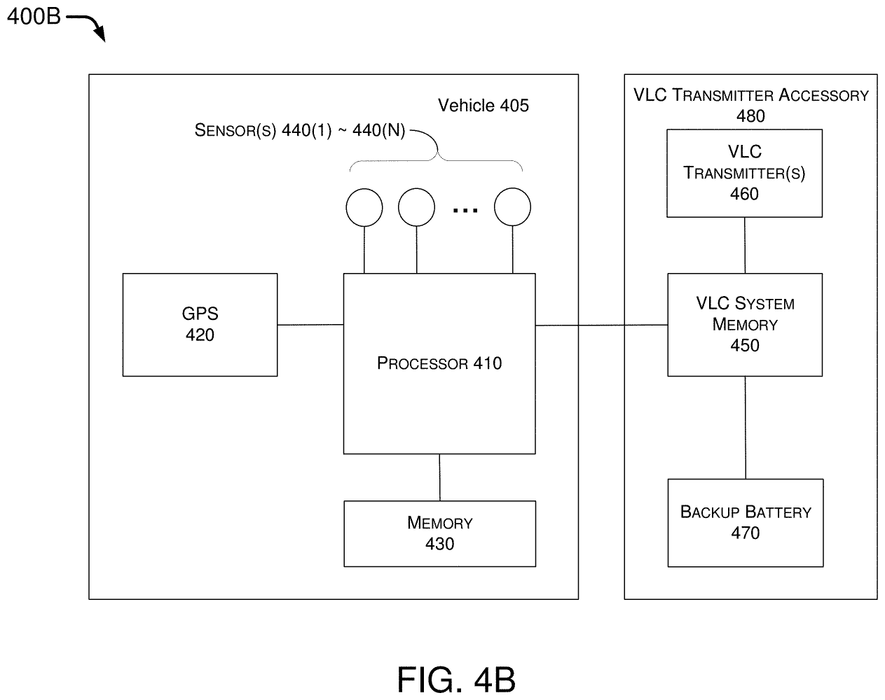

FIG. 4A illustrates an example system 400A in accordance with an embodiment of the present disclosure. FIG. 4B illustrates an example system 400B in accordance with an embodiment of the present disclosure. System 400B may be a variation of system 400A, and vice versa. Each of system 400A and system 400B may include a number of components pertinent to the present disclosure as well as a number of components not directly pertinent to the present disclosure. Thus, in the interest of brevity and not obscuring illustration of pertinent components, each of FIG. 4A and FIG. 4B shows those components pertinent to various embodiments of the present disclosure without showing those components that are not directly pertinent to the present disclosure.

Referring to FIG. 4A, system 400A may include a vehicle 405, which may be any of the vehicles discussed with respect to FIGS. 1-3. Vehicle 405 may include one or more computer processors 410. Vehicle may also include a GPS device 420, a memory 430, and a number of sensors 440(1)˜440(N) with N being a positive integer equal to or greater than 1. Vehicle 405 may further include a VLC system memory 450, one or more VLC transmitters 460, and a backup battery 470. Thus, in system 400A, all the above-listed components may be considered a VLC system, or a VLC apparatus, and may be integral parts of vehicle 405.

Referring to FIG. 4B, system 400B may include vehicle 405 and a VLC transmitter accessory 480. Vehicle 405 may include one or more computer processors 410. Vehicle 405 may also include a GPS device 420, a memory 430, and a number of sensors 440(1)˜440(N) with N being a positive integer equal to or greater than 1. VLC transmitter accessory 480 may include a VLC system memory 450, one or more VLC transmitters 460, and a backup battery 470. Thus, in system 400B, some of the above-listed components may be integral parts of vehicle 405 while some other of the above-listed components may be integral parts of VLC transmitter accessory 480. Some or all of the above-listed components may be considered a VLC system, or a VLC apparatus, of vehicle 405.

The following description applies to both system 400A and system 400B.

Memory 430 may be accessible by processors 410 and capable of storing data therein Similarly, VLC system memory 450 may also be accessible by processors 410 and capable of storing data (e.g., encoded information related to vehicle 405 and/or its passenger(s)) therein. Each of memory 430 and VLC system memory 450 may include a type of random-access memory (RAM) such as dynamic RAM (DRAM), static RAM (SRAM), thyristor RAM (T-RAM) and/or zero-capacitor RAM (Z-RAM). Alternatively, or additionally, some or all of memory 430 and VLC system memory 450 may include a type of read-only memory (ROM) such as mask ROM, programmable ROM (PROM), erasable programmable ROM (EPROM) and/or electrically erasable programmable ROM (EEPROM). Alternatively, or additionally, some or all of memory 430 and VLC system memory 450 may include a type of non-volatile random-access memory (NVRAM) such as flash memory, solid-state memory, ferroelectric RAM (FeRAM), magnetoresistive RAM (MRAM) and/or phase-change memory.

GPS device 420 may include a GPS chip capable of receiving information from GPS satellites to determine a location of vehicle 405. The location of vehicle 405 (e.g., GPS coordinates thereof) may be stored in memory 430. For instance, GPS device 420 may periodically (e.g., every second, every several seconds, every minute or every several minutes) store the GPS coordinates of then-current location of vehicle 405. Thus, when VLC communication is utilized, the last known GPS location of vehicle 405 may be encoded in the visible light to inform rescue units the whereabouts of vehicle 405.

Some or all of sensors 440(1)˜440(N) may be capable of sensing, detecting or otherwise measuring a respective condition or parameter and generate respective sensor data as a result of the sensing, detecting or measuring. The sensors 440(1)˜440(N) may include a camera, an ambient light sensor and/or a photodiode, which may be utilized to detect a direction of the open sky (e.g., upwards, etc.) as well as a visible light for VLC communication emitted by the rescue unit. The sensors 440(1)˜440(N) may also include various sensors (e.g., gyroscope, accelerometer, pressure sensor, and thermometer, etc.) to sense, detect or otherwise measure one or more conditions of vehicle 405 and/or its passenger(s). For instance, the sensors 440(1)˜440(N) may include sensors capable of sensing, detecting or otherwise measuring one or more conditions of vehicle 405 such as, for example and without limitation, an impact experienced by the vehicle, a condition of brakes of the vehicle, a temperature of the vehicle, a level of a battery of the vehicle, a level of a gas tank of the vehicle, and/or a combination thereof.

VLC transmitter(s) 460 may include one or more light sources capable of emitting visible light. For instance, VLC transmitter(s) 460 may include one or more light-emitting diodes (LEDs), one or more laser diodes, one or more visible light sources, and/or any combination thereof. In some embodiments, each VLC transmitter of VLC transmitter(s) 460 may be modulated in brightness, a frequency, a duty cycle, or any combination thereof, such that information related to vehicle 405 and/or its passenger(s) may be encoded in a signal in the form of modulation of the emitted visible light. In some embodiments, at least one VLC transmitter of VLC transmitter(s) 460 may be adjustable in terms of its orientation (e.g., by one or more actuators) so that the direction of light emitted by such VLC transmitter may be changed (e.g., toward the open sky or another direction). In the case of system 400B where VLC transmitter accessory 480 is a discrete unit separate from vehicle 405, encoded information may be saved or stored in VLC system memory 450 and may be transmitted from vehicle 405 to VLC transmitter accessory 480 by wire (e.g., through OBD II port, USB port or charging port) or wirelessly (e.g., through any available protocol such as Wi-Fi, Bluetooth or NFC). The driver/passenger of vehicle 405 may place VLC transmitter accessory 480 on top of vehicle 405 or in any suitable location and/or direction to transmit the encoded information in the form of a modulated visible light. In some cases, VLC transmitter accessory 480 may be hold by the driver/passenger as necessary.

Backup battery 470 may be an internal power supply capable of providing electrical power to other components of the VLC system including VLC transmitter(s) 460. For instance, backup battery 470 may enable the VLC system to continue to function by transmitting the encoded information even when a main battery of vehicle 405 is out of power.

Processors 410 may be capable of determining whether a condition with respect to vehicle 405 (or its passenger(s)) exists that requires assistance. In response to a determination that the condition exists (e.g., an emergency situation exists), processors 410 may save certain information in memory 430 such as, for example and without limitation, the latest GPS location of vehicle 405, a timestamp of corresponding to the GPS location, the latest status of vehicle 405, and/or any other information such as the number of passengers. Processors 410 may encode such information along with vehicle identification number (VIN) of vehicle 405 so as to enable the rescue unit to identify vehicle 405 and/or its passenger(s). Additionally, in response to the determination that the condition exists, processors 410 may determine availability of remote objects (e.g., other vehicles, satellites, Wi-Fi networks and/or cellular networks) with which vehicle 405 may communicate wirelessly (e.g., via V2V, V2X, Wi-Fi or any other suitable wireless communication technologies, specification, standards and/or protocols). In response to a determination that no remote object is available, processors 410 may control VLC transmitter(s) 460 to transmit a signal to request for assistance. Processors 410 may also detect, via one or more sensors of sensors 440(1)˜440(N), one other visible light (e.g., emitted by the rescue unit). Moreover, processors 410 may decode information encoded in the other visible light.

In some embodiments, in determining whether the condition exists, processors 410 may receive sensor data from one or more sensors of sensors 440(1)˜440(N) and determine, based on the sensor data, that one or more conditions exist that cause a request for assistance to be generated. Alternatively, in determining whether the condition exists, processors 410 may receive a user input (e.g., a voice command, a touch command provided on a touch-sensing panel, or a push of a button) that indicates a request for assistance is to be generated.

In some embodiments, in determining the availability of remote objects with which vehicle 405 can communicate wirelessly, processors 410 may determine availability of a vehicle, a mobile communication device, a satellite or a wireless network with which vehicle 405 can communicate wirelessly.

In some embodiments, in controlling VLC transmitter(s) 460 to transmit the signal, processors 410 may control VLC transmitter(s) 460 to emit visible light using one or more light-emitting diodes (LEDs), one or more laser diodes, one or more visible light sources, or a combination thereof.

In some embodiments, in controlling VLC transmitter(s) 460 to transmit the signal, processors 410 may control VLC transmitter(s) 460 to emit a modulated visible light indicating information related to vehicle 405.

In some embodiments, the information related to vehicle 405 may include a Global Positioning System (GPS) location of vehicle 405, a vehicle identification number (VIN) of vehicle 405, a timestamp, a name of a passenger of vehicle 405, a condition of vehicle 405, a condition of the passenger, or a combination thereof. In some embodiments, the condition of vehicle 405 may include an impact experienced by vehicle 405, a condition of brakes of vehicle 405, a temperature of vehicle 405, a level of a battery of vehicle 405, a level of a gas tank of vehicle 405, a speed history of vehicle 405, a path history of vehicle 405, or a combination thereof.

In some embodiments, in controlling VLC transmitter(s) 460 to emit the modulated visible light indicating the information related to vehicle 405, processors 410 may obtain the information related to vehicle 405 from one or more sensors and a memory associated with vehicle 405. Processors 410 may also encode the information related to vehicle 405 in the modulated visible light with on-off keying, pulse width modulation (PWM), pulse position modulation (PPM), and/or a combination thereof.

In some embodiments, in controlling VLC transmitter(s) 460 to emit the modulated visible light indicating the information related to vehicle 405, processors 410 may vary a brightness, a frequency, a duty cycle, or a combination thereof with respect to the modulated visible light. For instance, the encoded information may be repeatedly transmitted until the VLC system is disabled. The frequency of information transmission may be set to be high enough to transmit a signal carrying the encoded information a minimum number of signals per given amount of time (e.g., at least one, two, three, or more times per minute) when the rescue unit is expected to be within a VLC aperture range. If necessary, information of a high priority may be transmitted more frequently than other information of a lower priority. When rescue unit is expected to be in a higher altitude, a lower frequency of signal transmission may be utilized. If the VLC aperture angle is wide, a lower transmission frequency may be utilized. The frequency of information transmission may be controlled by the driver/passenger or by processors 410 according to ambient light sensor, altitude information of vehicle 405 or other sensor data. Accordingly, power consumption by the VLC system overall may be reduced and, correspondingly, VLC transmitter(s) 460 may be used for an increased amount of time.

In some embodiments, in controlling VLC transmitter(s) 460 to emit the modulated visible light indicating the information related to vehicle 405, processors 410 may prioritize a plurality of pieces of data of the information related to vehicle 405. Moreover, processors 410 may control VLC transmitter(s) 460 to emit the modulated visible light by emitting a first piece of data of the plurality of pieces of data more frequently than emitting a second piece of data of the plurality of pieces of data. In such cases, a priority of the first piece of data may be higher than a priority of the second piece of data. For instance, some or each piece of information may have its own priority (e.g., a higher priority for GPS location relative to a lower priority for sensor data, etc.), and thus information encoding may be done based on the priority.

In some embodiments, in controlling VLC transmitter(s) 460 to emit the modulated visible light indicating the information related to vehicle 405, processors 410 may determine either or both of an expected altitude of a rescue unit and a VLC aperture angle used in emitting the modulated visible light. Additionally, processors 410 may adjust a frequency at which the signal is transmitted according to either or both of the expected altitude of the rescue unit and the VLC aperture angle.

In some embodiments, in controlling VLC transmitter(s) 460 to transmit the signal, processors 410 may control VLC transmitter(s) 460 to emit a visible light toward one or more predefined directions.

In some embodiments, in controlling VLC transmitter(s) 460 to emit the visible light toward the predefined direction, processors 410 may receive sensor data from one or more sensors of sensors 440(1)˜440(N). Additionally, processors 410 may determine, based on the sensor data, a skyward direction. Moreover, processors 410 may adjust a direction of a VLC transmitter of VLC transmitter(s) 460 such that the VLC transmitter emits the visible light in the skyward direction.

In some embodiments, in controlling VLC transmitter(s) 460 to emit the visible light toward the predefined direction, processors 410 may receive sensor data from one or more sensors of sensors 440(1)˜44(N). Moreover, processors 410 may determine, based on the sensor data, a skyward direction. Additionally, processors 410 may identify a VLC transmitter of a plurality of VLC transmitters of VLC transmitter(s) 460 that is in the skyward direction. Furthermore, processors 410 may activate the identified VLC transmitter to emit the visible light in the skyward direction.

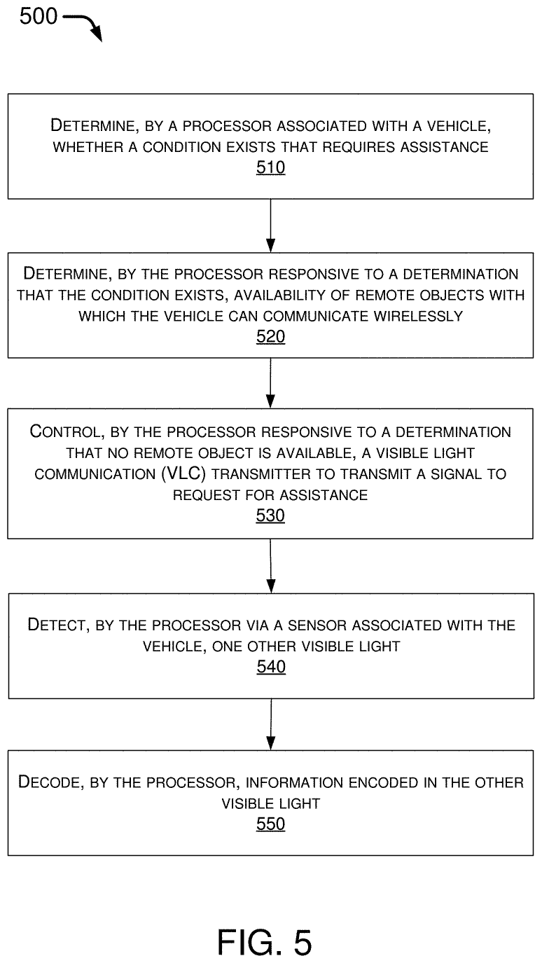

FIG. 5 illustrates a flowchart depicting an example process flow 500 in accordance with an embodiment of the present disclosure. Process flow 500 may include one or more operations, actions, or functions shown as blocks such as 510, 520, 530, 540 and 550 of FIG. 5. Although illustrated as discrete blocks, various blocks of process flow 500 may be divided into additional blocks, combined into fewer blocks, or eliminated, depending on the desired implementation. For illustrative purposes and without limitation, the following description of process flow 500 is provided in the context of use case 100 with, for example, system 400A or 400B implemented in vehicle 110 or any of the vehicles of FIGS. 1-4B. Process flow 500 may begin at block 510.

At block 510, process flow 500 may include one or more processors 410 associated with vehicle 110 determining whether a condition exists that requires assistance. Process flow 500 may proceed from block 510 to block 520 if it is determined that a condition exists or is present.

At block 520, process flow 500 may include processors 410 determining, in response to a determination that the condition exists, availability of remote objects with which vehicle 405 can communicate wirelessly. Process flow 500 may proceed from block 520 to block 530.

At block 530, process flow 500 may include processors 410 controlling, in response to a determination that no remote object is available, VLC transmitter(s) 460 to transmit a signal to request for assistance.

In some embodiments, in determining whether the condition exists or is present, process flow 500 may include processors 410 receiving sensor data from one or more sensors of sensors 440(10˜440(N) associated with vehicle 110. Additionally, process flow 500 may include processors 410 determining, based on the sensor data, that the condition exists that requires the request for assistance. For instance, the sensor data may indicate a condition such as, for example and without limitation, vehicle 110 being out of gas, vehicle 110 being included in a crash or accident, vehicle 110 having a flat tire, and so forth. Alternatively, in determining whether the condition exists, process flow 500 may include processors 410 receiving a user input that indicates a need for the request for assistance.

In some embodiments, in determining the availability of remote objects with which vehicle 110 can communicate wirelessly, process flow 500 may include processors 410 determining availability of a vehicle (e.g., vehicle 120 and/or vehicle 150), mobile communication device (e.g., a smartphone carried by a pedestrian), satellite (e.g., satellite 170) or wireless network (e.g., cellular network 140 and/or cellular network 160) with which vehicle 110 can communicate wirelessly.

In some embodiments, in controlling VLC transmitter(s) 460 to transmit the signal, process flow 500 may include processors 410 controlling VLC transmitter(s) 460 to emit visible light using one or more LEDs, one or more laser diodes, one or more visible light sources, and/or a combination thereof, of VLC transmitter(s) 460.

In some embodiments, in controlling VLC transmitter(s) 460 to transmit the signal, process flow 500 may include processors 410 controlling VLC transmitter(s) 460 to emit, via VLC transmitter(s) 460, a modulated visible light indicating information related to vehicle 110.

In some embodiments, the information related to vehicle 110 may include a GPS location of vehicle 110, a VIN of vehicle 110, a timestamp, a name of a passenger of vehicle 110, a condition of vehicle 110, a condition of the passenger, and/or a combination thereof. In some embodiments, the condition of vehicle 110 may include an impact experienced by vehicle 110, a condition of brakes of vehicle 110, a temperature of vehicle 110, a level of a battery of vehicle 110, a level of a gas tank of vehicle 110, a speed history of vehicle 110, a path history of vehicle 110, or a combination thereof.

In some embodiments, in controlling VLC transmitter(s) 460 to emit the modulated visible light indicating the information related to vehicle 110, process flow 500 may include processors 410 performing a number of operations. For instance, process flow 500 may include processors 410 obtaining the information related to vehicle 110 from one or more sensors of sensors 440(1)˜440(N) and memory 430 associated with vehicle 110. Moreover, process flow 500 may include processors 410 encoding the information related to vehicle 110 in the modulated visible light with on-off keying, PWM, PPM, or a combination thereof.

In some embodiments, in controlling VLC transmitter(s) 460 to emit the modulated visible light indicating the information related to vehicle 110, process flow 500 may include processors 410 varying a brightness, a frequency, a duty cycle, or a combination thereof with respect to the modulated visible light.

In some embodiments, in controlling VLC transmitter(s) 460 to emit the modulated visible light indicating the information related to vehicle 110, process flow 500 may include processors 410 performing a number of operations. For instance, process flow 500 may include processors 410 prioritizing a plurality of pieces of data of the information related to vehicle 110. Moreover, process flow 500 may include processors 410 controlling VLC transmitter(s) 460 to emit the modulated visible light by emitting a first piece of data of the plurality of pieces of data more frequently than emitting a second piece of data of the plurality of pieces of data, where a priority of the first piece of data is higher than a priority of the second piece of data.

In some embodiments, in controlling VLC transmitter(s) 460 to emit the modulated visible light indicating the information related to vehicle 110, process flow 500 may include processors 410 performing a number of operations. For instance, process flow 500 may include processors 410 determining either or both of an expected altitude of rescue unit 180 and a VLC aperture angle used in emitting the modulated visible light. Furthermore, process flow 500 may include processors 410 adjusting a frequency higher or lower at which the signal is transmitted according to either or both of the expected altitude of the rescue unit and the VLC aperture angle.

In some embodiments, in controlling VLC transmitter(s) 460 to transmit the signal, process flow 500 may include processors 410 controlling VLC transmitter(s) 460 to emit a visible light toward a certain direction.

In some embodiments, in controlling VLC transmitter(s) 460 to emit the visible light toward the predefined direction, process flow 500 may include processors 410 performing a number of operations. For instance, process flow 500 may include processors 410 receiving sensor data from one or more sensors of sensors 440(1)˜440(N). Additionally, process flow 500 may include processors 410 determining, based on the sensor data, a skyward or upward direction. Moreover, process flow 500 may include processors 410 adjusting a direction of a VLC transmitter of VLC transmitter(s) 460 such that the VLC transmitter emits the visible light in the skyward or upward direction.

Alternatively, in controlling VLC transmitter(s) 460 to emit the visible light toward the predefined direction, process flow 500 may include processors 410 performing different operations. For instance, process flow 500 may include processors 410 receiving sensor data from one or more sensors of sensors 440(1)˜440(N). Additionally, process flow 500 may include processors 410 determining, based on the sensor data, a skyward or upward direction. Moreover, process flow 500 may include processors 410 identifying a VLC transmitter of a plurality of VLC transmitters of VLC transmitter(s) 460 that is in the skyward direction. Furthermore, process flow 500 may include processors 410 activating the identified VLC transmitter to emit the visible light in the skyward direction.

In some embodiments, process flow 500 may include processors 410 performing additional operations, as represented by blocks 540 and 550. Process flow 500 may proceed from block 530 to block 540.

At block 540, process flow 500 may include processors 410 detecting, via a sensor associated with vehicle 110 (e.g., one of sensors 440(1)˜440(N) such as a camera, a light sensor or a photodiode), one other visible light (e.g., as emitted by rescue unit 180). Process flow 500 may proceed from block 540 to block 550.

At block 550, process flow 500 may include processors 410 decoding information encoded in the other visible light. For instance, the visible light transmitted by rescue unit 180 may include acknowledgement of receiving of the signal transmitted by vehicle 110 and/or an indication of an estimated time of arrival of rescue unit 180.

In the above disclosure, reference has been made to the accompanying drawings, which form a part hereof, and in which is shown by way of illustration specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure.

Example embodiments may include any one or more of the following:

Example 1 may include a method, comprising: determining, by one or more computer processors of a vehicle, that a condition is present, wherein presence of the condition causes a request for assistance to be generated; determining an availability of remote devices with which the vehicle can wirelessly communicate; determining that there are no remote devices available; and causing a visible light communication (VLC) transmitter of the vehicle to transmit a signal indicative of the request for assistance.

Example 2 may include the method of example 1 and/or some other example herein, wherein determining that the condition is present comprises: receiving sensor data from one or more sensors associated with the vehicle; and determining, using the sensor data, that the condition is present.

Example 3 may include the method of example 1 and/or some other example herein, wherein determining that the condition is present comprises: receiving a user input indicative of presence of the condition.

Example 4 may include the method of example 1 and/or some other example herein, wherein determining the availability of remote devices with which the vehicle can wirelessly communicate comprises: receiving a communication from a vehicle, a mobile communication device, or a satellite.

Example 5 may include the method of example 1 and/or some other example herein, wherein causing the VLC transmitter of the vehicle to transmit the signal indicative of the request for assistance comprises causing the VLC transmitter to emit visible light using one or more light-emitting diodes (LEDs), one or more laser diodes, one or more visible light sources, or a combination thereof.

Example 6 may include the method of example 1 and/or some other example herein, wherein causing the VLC transmitter of the vehicle to transmit the signal indicative of the request for assistance comprises causing the VLC transmitter to emit a modulated visible light indicating information related to the vehicle.

Example 7 may include the method of example 6 and/or some other example herein, wherein the information related to the vehicle comprises a Global Positioning System (GPS) location of the vehicle, a vehicle identification number (VIN) of the vehicle, a timestamp, a name of a passenger of the vehicle, a condition of the vehicle, a condition of the passenger, or a combination thereof.

Example 8 may include the method of example 7 and/or some other example herein, wherein the condition of the vehicle comprises an impact experienced by the vehicle, a condition of brakes of the vehicle, a temperature of the vehicle, a level of a battery of the vehicle, a level of a gas tank of the vehicle, a speed history of the vehicle, a path history of the vehicle, or a combination thereof.

Example 9 may include the method of example 6 and/or some other example herein, wherein causing the VLC transmitter of the vehicle to emit the modulated visible light indicating the information related to the vehicle comprises: obtaining the information related to the vehicle from one or more sensors associated with the vehicle; and encoding the information in the modulated visible light with on-off keying, pulse width modulation (PWM), pulse position modulation (PPM), or a combination thereof.

Example 10 may include the method of example 6 and/or some other example herein, wherein causing the VLC transmitter of the vehicle to emit the modulated visible light indicating the information related to the vehicle comprises varying a brightness, a frequency, a duty cycle, or a combination thereof with respect to the modulated visible light.

Example 11 may include the method of example 6 and/or some other example herein, wherein VLC transmitter of the vehicle to emit the modulated visible light indicating the information related to the vehicle for assistance comprises: determining respective priority for a plurality of data of the information related to the vehicle; and emitting the modulated visible light by emitting a first piece of data of the plurality of pieces of data more frequently than emitting a second piece of data of the plurality of pieces of data, wherein a first priority of the first piece of data is higher than a second priority of the second piece of data.

Example 12 may include the method of example 6 and/or some other example herein, wherein causing the VLC transmitter of the vehicle to emit the modulated visible light indicating the information related to the vehicle comprises: determining an expected altitude of a rescue unit and a VLC aperture angle used in emitting the modulated visible light; and adjusting a frequency at which the signal is transmitted according to the expected altitude of the rescue unit and the VLC aperture angle.

Example 13 may include the method of example 1 and/or some other example herein, wherein causing the VLC transmitter of the vehicle to transmit the signal indicative of the request for assistance comprises causing the VLC transmitter to emit a visible light toward a predefined direction.

Example 14 may include the method of example 13 and/or some other example herein, wherein causing the VLC transmitter to emit the visible light toward the predefined direction comprises: receiving sensor data from one or more sensors associated with the vehicle; determining, based on the sensor data, a skyward direction; and adjusting a direction of the VLC transmitter such that the VLC transmitter emits the visible light in the skyward direction.

Example 15 may include the method of example 13 and/or some other example herein, wherein causing the VLC transmitter to emit the visible light toward the predefined direction comprises: receiving sensor data from one or more sensors associated with the vehicle; determining, based on the sensor data, a skyward direction; identifying one VLC transmitter of a plurality of VLC transmitters that is oriented in the skyward direction; and activating the identified VLC transmitter to emit the visible light in the skyward direction.

Example 16 may include the method of example 1 and/or some other example herein, further comprising: detecting the visible light; and decoding the visible light to determine information encoded in the visible light.

Example 17 may include an apparatus implementable in a vehicle, comprising: one or more sensors; a visible light communication (VLC) transmitter; and at least one processor communicatively coupled to the one or more sensors and the VLC transmitter, the at least one processor configured to perform operations comprising: determine that a condition is present, wherein presence of the condition causes a request for assistance to be generated; determine an availability of remote devices with which the vehicle can wirelessly communicate; determine that there are no remote devices available; and cause a visible light communication (VLC) transmitter of the vehicle to transmit a signal indicative of the request for assistance.

Example 18 may include the apparatus of example 17 and/or some other example herein, wherein, in causing the VLC transmitter to transmit the signal indicative of the request for assistance, the at least one processor causes the VLC transmitter to emit a modulated visible light indicating information related to the vehicle by varying a brightness, a frequency, a duty cycle, or a combination thereof with respect to the modulated visible light.

Example 19 may include the apparatus of example 17 and/or some other example herein, wherein, in causing the VLC transmitter to transmit the signal indicative of the request for assistance, the at least one processor causes the VLC transmitter to emit the visible light toward a predefined direction by: receiving sensor data from one or more sensors associated with the vehicle; determining, based on the sensor data, a skyward direction; and adjusting a direction of the VLC transmitter such that the VLC transmitter emits the visible light in the skyward direction:

Example 20 may include the apparatus of example 17 and/or some other example herein, wherein the at least one processor is further configured to perform operations comprising: detecting, via the one or more sensors, the visible light; and decoding information encoded in the visible light.

1. A method, comprising:
determining, by one or more computer processors of a vehicle, that a condition is present, wherein presence of the condition causes a request for assistance to be generated;
determining an availability of remote devices with which the vehicle can wirelessly communicate;
determining that there are no remote devices available;
receiving sensor data from one or more sensors associated with the vehicle;
determining, based on the sensor data, a skyward direction; and
causing a direction of a visible light communication (VLC) transmitter of the vehicle to be adjusted, such that the VLC transmitter emits the visible light in the skyward direction.

2. The method of claim 1, wherein determining that the condition is present comprises:
receiving sensor data from the one or more sensors associated with the vehicle; and
determining, using the sensor data, that the condition is present.

3. The method of claim 1, wherein determining that the condition is present comprises:
receiving a user input indicative of presence of the condition.

4. The method of claim 1, wherein determining the availability of remote devices with which the vehicle can wirelessly communicate comprises:
receiving a communication from a vehicle, a mobile communication device, or a satellite.

5. The method of claim 1, further comprising causing the VLC transmitter of the vehicle to emit visible light using one or more light-emitting diodes (LEDs), one or more laser diodes, one or more visible light sources, or a combination thereof.

6. The method of claim 1, further comprising causing the VLC transmitter of the vehicle to emit a modulated visible light indicating information related to the vehicle.

7. The method of claim 6, wherein the information related to the vehicle comprises a Global Positioning System (GPS) location of the vehicle, a vehicle identification number (VIN) of the vehicle, a timestamp, a name of a passenger of the vehicle, a condition of the vehicle, a condition of the passenger, or a combination thereof.

8. The method of claim 7, wherein the condition of the vehicle comprises an impact experienced by the vehicle, a condition of brakes of the vehicle, a temperature of the vehicle, a level of a battery of the vehicle, a level of a gas tank of the vehicle, a speed history of the vehicle, a path history of the vehicle, or a combination thereof.

9. The method of claim 6, wherein causing the VLC transmitter of the vehicle to emit the modulated visible light indicating the information related to the vehicle comprises:
obtaining the information related to the vehicle from the one or more sensors associated with the vehicle; and
encoding the information in the modulated visible light with on-off keying, pulse width modulation (PWM), pulse position modulation (PPM), or a combination thereof.

10. The method of claim 6, wherein causing the VLC transmitter of the vehicle to emit the modulated visible light indicating the information related to the vehicle comprises varying a brightness, a frequency, a duty cycle, or a combination thereof with respect to the modulated visible light.

11. The method of claim 6, wherein VLC transmitter of the vehicle to emit the modulated visible light indicating the information related to the vehicle for assistance comprises:
determining respective priority for a plurality of data of the information related to the vehicle; and
emitting the modulated visible light by emitting a first piece of data of the plurality of data more frequently than emitting a second piece of data of the plurality of data, wherein a first priority of the first piece of data is higher than a second priority of the second piece of data.

12. The method of claim 6, wherein causing the VLC transmitter of the vehicle to emit the modulated visible light indicating the information related to the vehicle comprises:
determining an expected altitude of a rescue unit and a VLC aperture angle used in emitting the modulated visible light; and
adjusting a frequency at which the signal is transmitted according to the expected altitude of the rescue unit and the VLC aperture angle.

13. The method of claim 1, further comprising causing the VLC transmitter of the vehicle to to emit a visible light toward a predefined direction.

14. (canceled)

15. The method of claim 13, further comprising: wherein causing the VLC transmitter to
identifying one VLC transmitter of a plurality of VLC transmitters that is oriented in the skyward direction; and
activating the identified VLC transmitter to emit the visible light in the skyward direction.

16. The method of claim 15, further comprising:
detecting the visible light; and
decoding the visible light to determine information encoded in the visible light.

17. An apparatus implementable in a vehicle, comprising:
one or more sensors;
a visible light communication (VLC) transmitter; and
at least one processor communicatively coupled to the one or more sensors and the VLC transmitter, the at least one processor configured to perform operations comprising:
determine that a condition is present, wherein presence of the condition causes a request for assistance to be generated;
determine an availability of remote devices with which the vehicle can wirelessly communicate;
determine that there are no remote devices available; and
receive sensor data from one or more sensors associated with the vehicle;
determine, based on the sensor data, a skyward direction; and
cause a direction of a visible light communication (VLC) transmitter of the vehicle to be adjusted, such that the VLC transmitter emits the visible light in the skyward direction.

18. The apparatus of claim 17, wherein, in causing the VLC transmitter to transmit the signal indicative of the request for assistance, the at least one processor causes the VLC transmitter to emit a modulated visible light indicating information related to the vehicle by varying a brightness, a frequency, a duty cycle, or a combination thereof with respect to the modulated visible light.

19. (canceled)

20. The apparatus of claim 17, wherein the at least one processor is further configured to perform operations comprising:
detecting, via the one or more sensors, the visible light; and
decoding information encoded in the visible light.
